(19) United States
(12) Patent Application Publication
(10) Pub. No.: US 2003/0040413 A1
(43) Pub. Date: Feb. 27, 2003

(54) Case erector

(76) Inventors: Joseph Malecki, Hinsdale, IL (US); Robert Zatorski, Romeoville, IL (US)

Correspondence Address: POLIT & ASSOCIATES, LLC, 3333 WARRENVILLE ROAD, SUITE 520, LISLE, IL, 60532, US

(21) Appl. No.: 09/939,358

(22) Filed: Aug. 24, 2001

(51) Int. Cl. B31B 1/78

(52) U.S. Cl. 493/309

(57) ABSTRACT

A case erector receives a horizontal stack of flattened cases of varying case size as input, and automatically adjusts to output a stream of formed cubical cases, each case having a rectangular cross-section and a closed bottom end. The case erector includes a sensor for determining the case size signal from the sensor, and plural adjustment devices, responsive to the controller to automatically adjust the case erector to erect the particular case size. The case erector includes a case input magazine that can receive cases of one size or cases of varying size. The magazine includes a rack having a V-shaped supporting surface. The V-shaped supporting surface spans approximately 90° and is bisected by a vertical plane. The V-shaped supporting surface is tilted at an angle downwardly along a direction of case propagation feed into the case forming section of the case erector.

### TECHNICAL FIELD OF THE INVENTION

The invention relates to machines for erecting cases. Particularly, the invention relates to machines which automate the manipulation of flattened cases so as to be rectangular in cross-section, and the manipulation and securement of flaps on one end of the case to form a closed end.

### BACKGROUND OF THE INVENTION

Conventional cardboard or corrugated board cases or cartons of the four-flap style are typically shipped to packaging companies in a flattened state. The flattened cases are provided with four fold lines to allow manipulation of the case from the flattened state into a rectangular tube. The four flaps at the bottom of the tube are respectively separated by four slots that are respectively colinear with the four fold lines. After the flattened case is formed into a rectangular tube, the four flaps on at least the bottom end of the case are sequentially folded over forming a closed end and secured with a strip of tape, to form a cubical case with an open top.

Case erector machines for setting-up cubical cases from flattened cases are generally known, such as disclosed in U.S. Pat. Nos. 4,067,172; 4,579,551; 5,112,288; and 5,689,931.

U.S. Pat. No. 4,067,172 discloses a typical system wherein a vertical stack of flattened cases is held in a case magazine, with the cases in a horizontal orientation. The magazine is adjustable to hold a preselected case size within a range of case sizes. The cases are dispensed from the magazine wherein the lowest case is pulled downwardly from the magazine. The cases are each transformed from a flattened case to a rectangular cross-section case by a horizontally moving set-up finger.

At a side open end of the case, a rotatable arm and a fixed cam close the vertical flaps, and a stationery cam folds the bottom flap. The top flap is temporarily held open. The flaps of the opposite open end of the case are folded closed in the same manner after the case is filled with a product. The top flaps of both ends are folded and closed after adhesive is applied to bottom surfaces thereof.

Another type of case erector, similar to that disclosed in U.S. Pat. No. 4,579,151, includes a magazine arranged to hold vertically oriented, and horizontally stacked flattened cases, the stack tilted toward a case feeding direction, with bottom edges of the flattened cases supported horizontally. A transport uses suction cups to transport a leading case of the flattened cases to a longitudinal transport. The leading case is manipulated into a rectangular tube, and the bottom flaps of the rectangular tube are folded from below to create a closed bottom end, by use of moving plates and stationary ploughs. A taping mechanism within the longitudinal transport path is used to secure the bottom end.

These type case erectors typically require substantial manual adjustments for changing case size. The adjustments can be time consuming and prone to errors.

The present inventors have recognized the desirability of providing a case or case-erecting machine that minimizes the need to manually adjust a case magazine to accommodate different size cases. The present inventors have recognized the desirability of providing a case erector which can receive a stream of flattened cases of mixed sizes, and outputs a stream of corresponding rectangular cross-section cases having a closed and secured bottom end.

The present inventors have recognized the desirability to remove the human element when changing over the machine from one size flattened case to another.

### SUMMARY OF THE INVENTION

The present invention provides a case erector that is adapted to receive a horizontal stack of flattened cases of varying case size as input, and automatically adjusts to output a stream of formed cubical cases, each case having a rectangular cross-section and a closed bottom end. The case erector includes a sensor for determining the case size, a controller that receives a case size signal from the sensor, and plural adjustment devices, responsive to the controller to automatically adjust the case erector to erect the particular case size.

The case erector of the present invention includes a case magazine that can receive cases of one size or cases of varying size. The case magazine is mounted adjacent a case forming section of the case erector to feed cases into the case forming section. The magazine includes a rack having a V-shaped cross-section defined by two supporting surfaces. The supporting surfaces span an angle of approximately 90° and are tilted obliquely from a vertical plane. The supporting surfaces define a line of intersection that is tilted at an angle downwardly along a direction of case propagation into the case forming section of the case erector.

The cases are held behind retaining lips on a front face of the supporting surfaces. One or more pneumatically operated pushers are arranged adjacent to one of the supporting surfaces and are selectively activated to push a stack-leading case to a release position, clearing the retaining lips the one supporting surface. A case transfer arm engages the leading case and displaces the case from the retaining lip of the respective other supporting surface and places the case in a staging position. At the staging position, a sensor determines the position of a slot which defines the length of the end flaps, which in turn defines the case size. Using this sensed information, a plurality of adjustable manipulation or transport devices on the case erector can be automatically adjusted for a particular case size. This case size sensing routine can be undertaken for each case moved by the transfer arm from the front face of the supporting surfaces to the staging position.

The sensor can be an optical sensor mounted on a carriage. The carriage is driven along a transport rod in a direction parallel to a predominant face of the case at the staging position. The carriage is driven from a home position to a position where a case slot, located between a side bottom flap and a rear bottom flap of the flattened case, is sensed by the optical sensor. At that point, the carriage position and the case size is calculated by the controller.

The controller advantageously provides an automatic adjustment of a substantial portion of, or all of, the necessary clearances and movements of the case erector that are necessary when changing case size.

Also advantageous is the fact that the magazine of the present invention accepts cases of varying sizes without the need to adjust a support on the magazine to hold the cases, due to the orientation and configuration of the V-shaped supporting surface of the magazine.

Numerous other advantages and features of the present invention will be become readily apparent from the following detailed description of the invention and the embodiments thereof, from the claims and from the accompanying drawings.

### BRIEF DESCRIPTION OF THE DRAWINGS

FIG. 1 is a perspective view of a case erector apparatus of the invention;

FIG. 2 is an elevational view of a flattened case;

FIG. 3 is a bottom perspective view of the case of FIG. 2 set up into a cubical case with a bottom end closed and taped;

FIG. 4 is a schematic plan view of a case erector machine of the invention;

FIG. 5 is a sectional view taken generally along line 5-5 of FIG. 4;

FIG. 6 is a sectional view taken generally along line 6-6 of FIG. 4;

FIG. 7 is an end view taken generally along line 7-7 of FIG. 6;

FIG. 8 is an enlarged fragmentary sectional view taken generally along line 8-8 of FIG. 1;

FIG. 9 is an enlarged fragmentary perspective view of a staging transport taken from FIG. 1;

FIG. 10 is an enlarged fragmentary perspective view of a position sensor taken from FIG. 1;

FIG. 11 is an enlarged fragmentary perspective view taken of the position sensor from FIG. 10;

FIG. 12 is a schematical exploded perspective view of the progressive formation of the case shown in FIG. 2 into the case shown in FIG. 3;

FIG. 13 is a sectional view taken generally along lines 13-13 of FIG. 12;

FIG. 14 is a sectional view taken generally along lines 14-14 of FIG. 12; and

FIG. 15 is a block flow diagram of a control system of the invention.

### DETAILED DESCRIPTION OF THE PREFERRED EMBODIMENTS

While this invention is susceptible of embodiment in many different forms, there are shown in the drawings, and will be described herein in detail, a specific embodiment thereof with the understanding that the present disclosure is to be considered as an exemplification of the principles of the invention and is not intended to limit the invention to the specific embodiment illustrated.

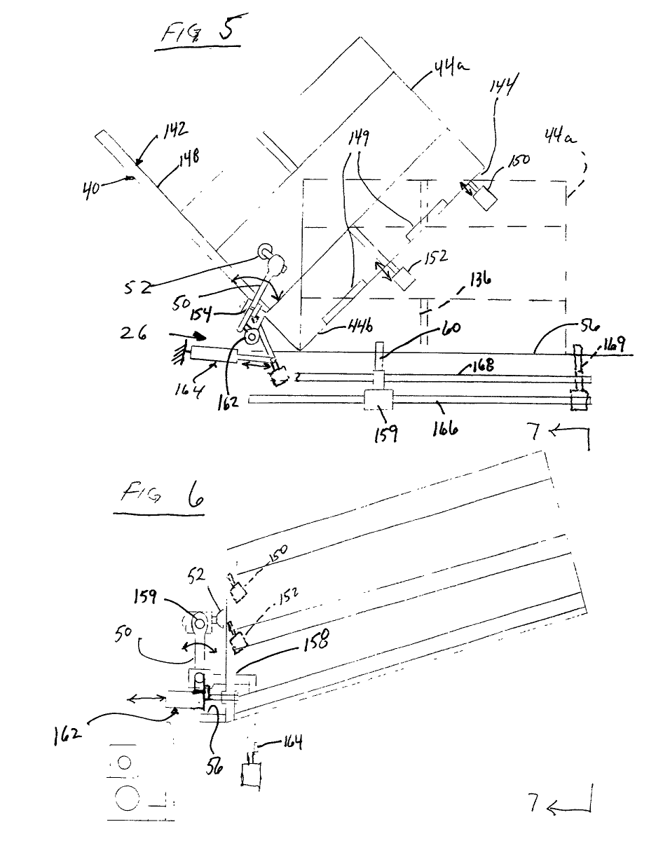

FIGS. 1 and 4 illustrate a case erector apparatus 20 of the invention. The apparatus 20 includes a flattened case input station 24, and a case forming apparatus 25. The case forming apparatus 25 includes a case staging transport 26, a lateral case transport 28, a longitudinal case transport 32, and a longitudinal case conveyor 36. The transports 26, 28, 32 and the conveyor 36 are all signal-connected and controlled by a controller 38.

The input station 24 includes a magazine 40 which carries a plurality of flattened cases 44 (as shown in FIGS. 4 and 5), vertically oriented and horizontally stacked, and of varying sizes. The case sizes can vary randomly or case sizes can be arranged in groups, the size changing only after the group is depleted.

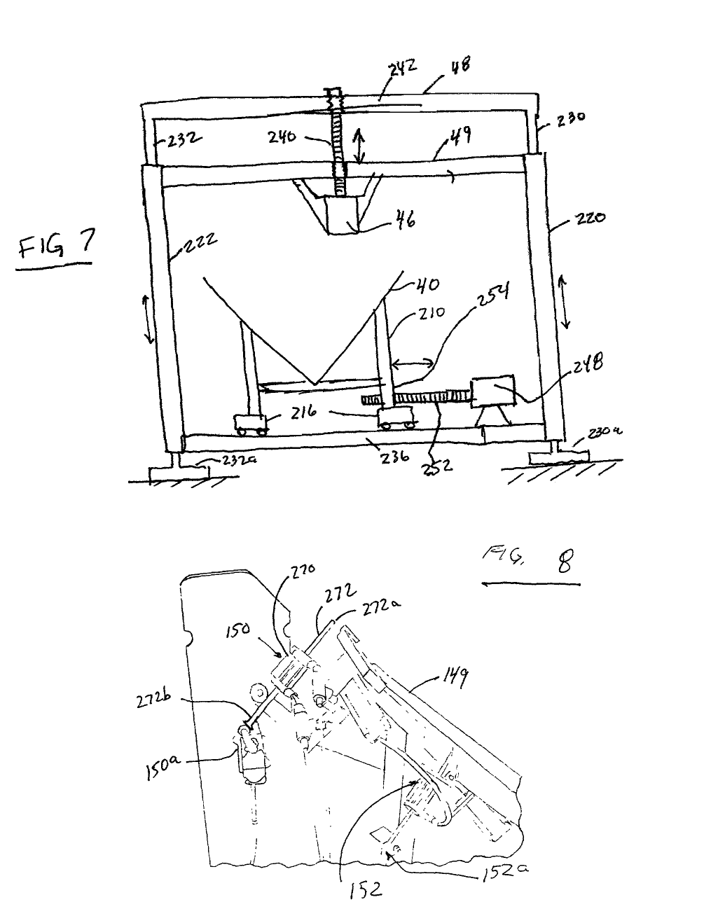

The magazine 40 can be vertically adjusted by a servomotor 46 which drives a threaded rod connected between a floor supported frame 48 and a magazine supporting frame 49. The magazine 40 can be horizontally adjusted in longitudinal position by use of a servomotor and an interposed carriage between the floor and the floor supported frame 48, shown in FIG. 7.

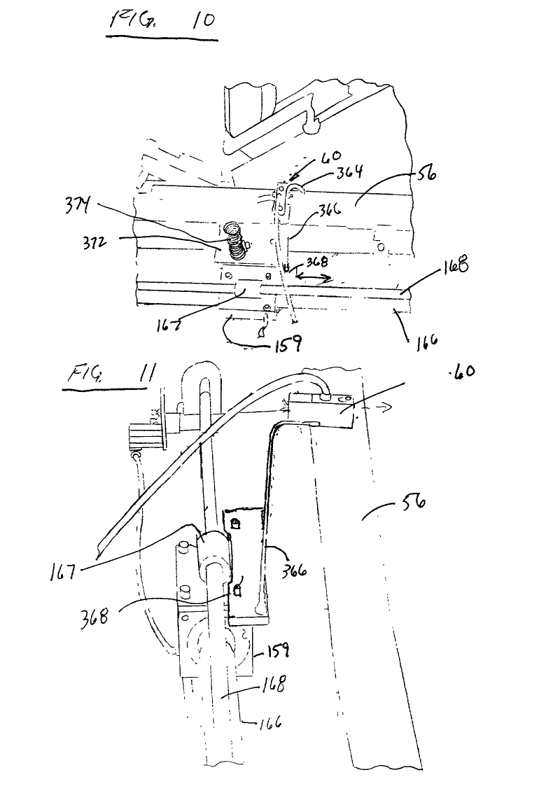

The case staging transport 26 includes a pivoting transfer arm 50 (shown in FIGS. 5, 6 and 9) having a suction cup 52 which engages a leading flattened case 44a within the magazine 40. The arm 50 moves the case 44a out of the magazine 40 and onto a staging ledge or platform 56. A sensor 60 (shown in FIGS. 10 and 11), such as an optical sensor, is movable horizontally along the ledge 56, facing the case 44a. The sensor 60 is signal connected to the controller 38. The sensor 60 is operable to determine the size of each successive leading case 44a as described below.

The lateral transport 28 includes a conveyor 68 driven by a servomotor 70, which laterally moves a carriage 71. The carriage 71 carries an extending arm 72. The extending arm 72 carries a plurality of suction cups 76. In operation, the conveyor 68 moves the extending arm 72 and suction cups 76 from a retracted position shown to a position (shown in phantom in FIG. 4) adjacent to the first case 44a on the staging platform 56. The conveyor 68 moves the suction cups 76 to engage the case 44a on the ledge 56. The conveyor 68 then moves the suction cups 76 along with the case 44a from right to left in FIG. 4. A portion of the flattened case 44a is pressed by a stationary plough 80 to open the flattened case to a rectangular cross-section or rectangular tube (shown in phantom in FIG. 4), as the case is moved from right to left. The conveyor 68 retracts to position the case 44a in a “handoff” position along a longitudinal centerline CL of the case forming apparatus 25.

The case erector apparatus 20 includes various components which are well known to one of skill in the art. For example, each suction cup comprises a resilient cup mounted to a tubular housing having a through channel open into a central opening of the suction cup. The housing includes a suction inlet port such that a vacuum can be drawn through the suction cup and through the housing. Vacuum for the suction cup is typically created by a pneumatically powered vacuum pump. The suction cup can engage and hold, by suction pressure, the case 44a.

Pneumatic cylinders are also described which typically comprise a cylinder body having inlet outlet ports at opposite ends of the body. A rod passes longitudinally through end seals of the body and a piston is fixed to the rod within the body. Depending on the differential pneumatic pressure applied to the ports, the piston is forced to slide within the body in a selected direction.

The longitudinal transport 32 includes a longitudinal conveyor 84 driven by a servomotor 85, and suction cups 86 carried by the conveyor 84. The transport 32 also includes a controllably pivotable plate 88 which pivots upward to close a rear flap of the case 44a. A pneumatic cylinder 89 (shown schematically in FIG. 1) expands and contracts to control movement of the plate 88. The conveyor 84 moves longitudinally to engage the suction cups 86 to the case 44a at the handoff position and continues longitudinally to position the case a sufficient distance to be engaged and transported by the conveyor 36.

The conveyor 36 includes side conveyor belts 102, 104 which are spaced apart by a precise distance to grip the case 44a between the belts. A servomotor 106 drives parallel threaded rods 107a, 107b via a chain 107c. The threaded rods 107a, 107b are threadingly engaged to moveable base members 102a, 104a of the belts 102, 104. By turning the servomotor 106 in a selected direction by a selected amount, a precise spacing of the belts 102, 104 is achieved. The belts 102, 104 are circulated in opposite directions to transport the case along the conveyor 36. Within the area of the conveyor 36 are a stationary center plough 108 for closing the front flap of the moving case, and stationary side flap ploughs 114, 116 for progressively closing side flaps of the moving case 44a. A taping mechanism 124 (shown schematically) is located downstream of the ploughs 108, 114, 116 to secure the bottom of the case 44a. The taping mechanism 124 can be a type disclosed, for example, in U.S. Pat. Nos. 4,640,731 or 4,061,526.

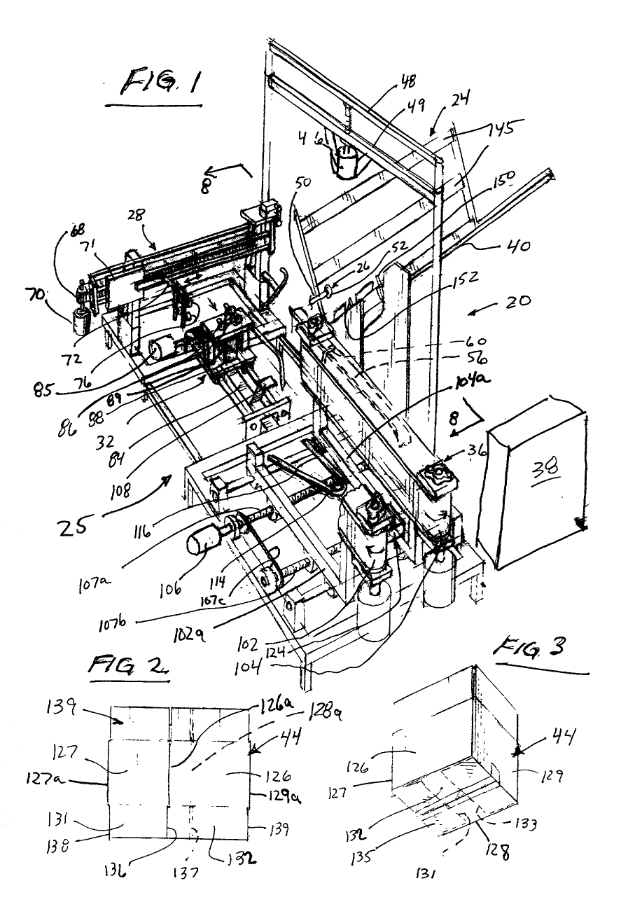

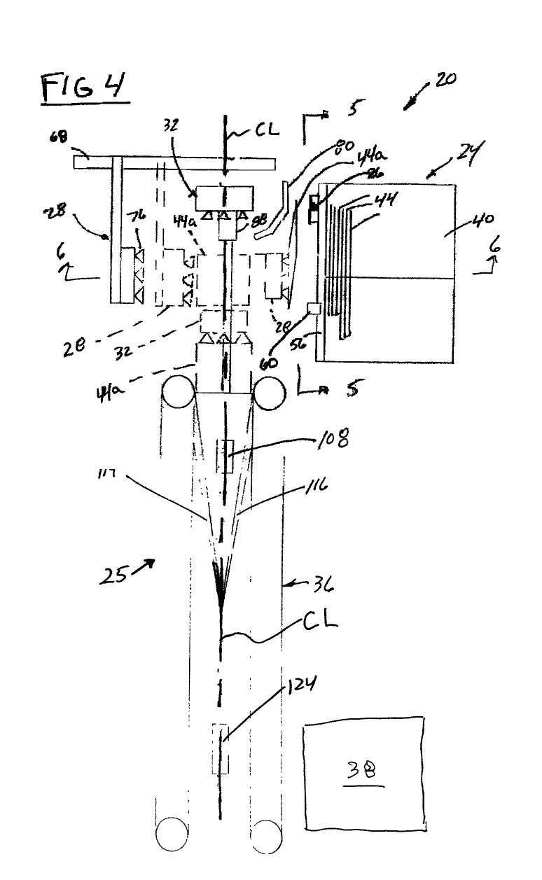

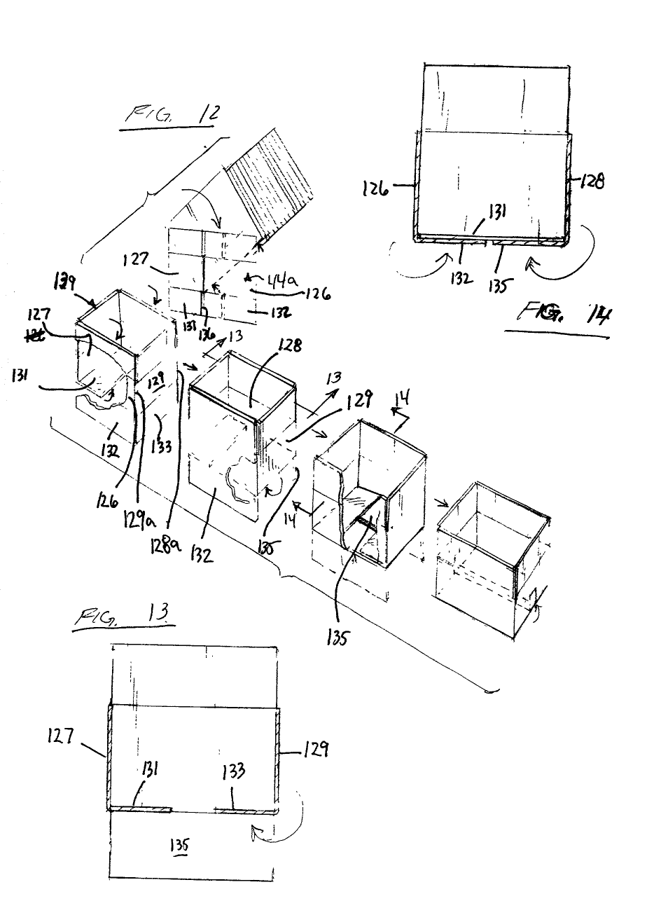

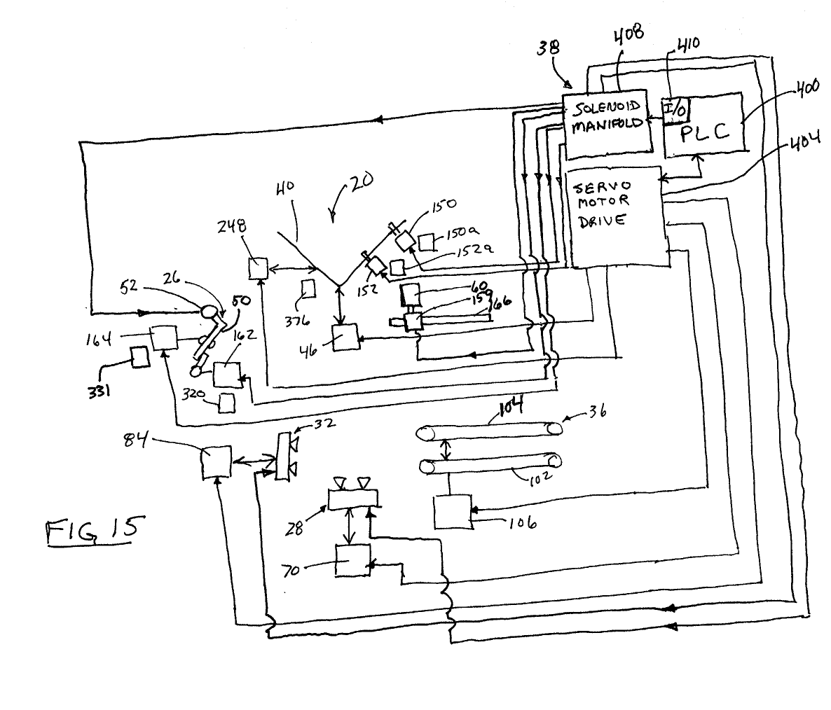

FIGS. 2 and 3 illustrates a flattened case 44 and a formed cubical case 44. FIGS. 12-14 illustrate in step fashion the forming of the cubical case 44 from the flattened case 44. The case 44 is preferably composed of cardboard or corrugated board. The case 44 includes a side wall 126 and an end wall 127 separated by a fold line 126a on the facing predominant side. The case 44 includes a reverse mirror image side wall 128 and end wall 129, separated by a fold line 128a, on the reverse predominant side. Below the wall 127 is an end flap 131. Below the sidewall 126 is a side flap 132. Reverse mirror image front flap 133 and side flap 135 are also provided beneath the side wall 128 and end wall 129. Fold lines 127a, 129a are provided between the predominant side and the reverse predominant side. Slots 136, 137, 138, 139, colinear with respective fold lines, are provided between the respective flaps 131, 132, 133, 135.

A top flap arrangement 139 is also provided. The top flap arrangement would be closed by a mechanism (not shown) after a product is placed into the case.

FIGS. 5 and 6 illustrates the magazine 40 comprising a rack having a V-shaped cross section forming a 90° angle and preferably bisected by a vertical plane. The rack comprises first and second supporting surfaces 142, 144. The supporting surfaces are defined by a plurality of spaced rails 145 (as shown in FIG. 1). The supporting surfaces 142, 144 define a line of intersection that is inclined at an angle of about 20° from the ledge 56, rising in a rearward direction (into the page of FIG. 5). Retaining lips 148, 149 are arranged along front edges of the supporting surfaces 142, 144, respectively. The lips 148, 149 retain the first case 44a, and cases behind the first case, in the magazine 40.

A first pneumatically operated pusher 150 and a second pneumatically operated pusher 152 are arranged along an edge of the second supporting surface 144 and are operable to lift an edge 44b of the case 44a from the remaining cases 44 and above the lips 149.

The pivot arm 50 (shown and explained in detail below with respect to FIG. 9) is pivotally connected at a first joint 154 to rotate about an axis parallel to the longitudinal center line CL and is pivotally connected at a second joint 158 to rotate about an axis parallel to the lateral direction, the lateral direction being horizontal and perpendicular to the longitudinal direction.

A first pneumatic cylinder 162 controls rotation about the first joint 154 and a second pneumatic cylinder 164 controls rotation about the second joint 158. The rotation about the second joint 158 allows the arm 50 to rotate to position the suction cup 52 facing the flattened case 44a. The arm 50 includes a third joint 159 at the suction cup 52 to allow the cup axis to remain perpendicular to the flattened case 44a.

Rotation about the first joint 154 allows the suction cup 52 to be rotated toward and away from the flattened case 44a to engage and then withdraw the flattened case 44a from the magazine 40. The arm 50 can then be further rotated about the second joint 158 to place the leading flattened case 44a flushly onto the ledge 56.

The sensor 60 includes a carriage 159, preferably in the form of a pneumatically translated rodless cylinder, which is moveable on a transport rod 166. A guide rail 168 is located above the transport rail. The carriage includes a bearing 167 slideable along the guide rail 168. The bearing 167 and guide rail 168 structurally act to ensure verticality of the sensor 60. The sensor 60 is moved via the carriage 159 along the transport rod 166 from a home position 169 and issues a signal to the controller 38 when the case slot 136 is sensed by the sensor 60. The movement of the sensor 60 from start to the position where the slot 136 is sensed is timed by the controller 38 to determine a distance traveled by the sensor and hence the position of the slot, given the known acceleration and speed of the carriage. The location of the case slot 136 defines the case size. The slot location information is used by the controller 38 to make machine adjustments as described below.

From the ledge 56, the lateral transport suction cups 76 engage the case 44a. The suction cup 52 is then disengaged, and the arm 50 is rotated about the second joint 158 to a position of noninterference with movement of the case 44a during withdrawal by the conveyor 68.

FIG. 7 illustrates a magazine 40 supported on a magazine carriage 210. The magazine carriage 210 is slidably supported on rollers or bearings 216. The bearings 216 are supported on one or more horizontal members 236 of the frame 49.

The frame 49 includes external pipe columns 220, 222 which slidably receive internal pipe columns 230, 232 of the frame 48. The internal pipe columns 230, 232 are supported at base ends 230a, 232a thereof on the floor or on a frame of the apparatus 25.

The vertical adjustment servomotor 46 drives a threaded rod 240 which threadingly engages a top member 242 of the frame 248. By turning the threaded rod 240 with the servomotor 46 the frame 49 is drawn toward or retracted away from the frame 48 to set the vertical position of the magazine 40. A horizontal adjustment servomotor 248 drives a threaded rod 252 which is threadingly engaged to a member 254 of the carriage 210. By turning the motor 248 in a selected direction, the magazine carriage 210 is moved horizontally (left or right) on the frame 49.

Thus, by selectively operating the servomotors 46, 248 the magazine 40 can be positioned precisely in vertical and longitudinal position.

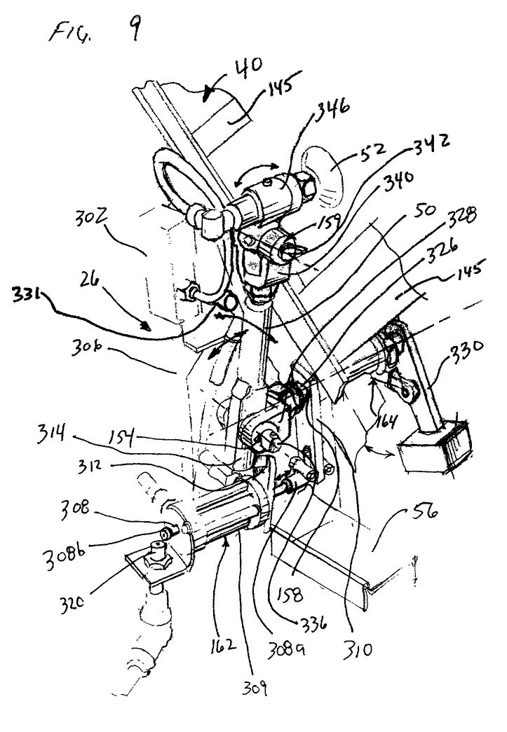

FIG. 8 illustrates the pushers 150, 152 each comprising a pneumatically operated cylinder 270 which acts on a through rod 272. A first end 272a of the through rod 272 is operable to lift the edge 44b of the flattened case 44a. Preferably the pusher 150 is tilted upwardly in a forward direction as shown in phantom in FIG. 6. This assists in pushing the edge upwardly and outwardly to clear the retaining lips 149. A sensor switch 150a is operatively oriented with an opposite end 272b of the rod 272 such that movement of the rod can be indicated and the signal communicated to the controller 38. A similar switch 152a is provided for the pusher 152.

FIG. 9 illustrates the transport mechanism 26 in more detail. A vacuum pump 302 is tube-connected to the suction cup 52. The vacuum pump 302 is actuated by pneumatic pressure from a tube 306. The pneumatic cylinder 162 includes a through rod 308 which is moveable in a longitudinal direction. A first end 308a is connected by a bracket 310 to the stationary magazine structure. The cylinder body 309 is fixed by an L-shaped bracket 312 to a base end 314 of the rod 50. Under pneumatic pressure in one direction, the cylinder body 309 is drawn toward the bracket 310 which causes the rod 50 to pivot away from the magazine 40. Upon selected differential pneumatic pressure in an opposite direction, the cylinder body 309 is moved away from the bracket 310 which causes the rod 50 to pivot toward the magazine 40. An opposite end 308b of the rod 308 is moveable close to a proximity switch 320 which sends a position signal of the rod 50 to the controller 38.

The joint 158 is formed by a through shaft 326 connected via a yoke 328 to the arm 50 and which shaft 326 passes through a front face of the magazine 40 and is connected at a rear thereof to the pneumatic cylinder 164 via a crank lever 330. The position of the arm 50 is detected by an optical sensor 331.

The joint 154 is formed by a short axle which is fixed to the arm 50 and which passes rotationally through opposite arms of the yoke 328, allowing pivoting motion of the axle 336 with respect to the yoke 328.

The joint 159 is formed by a yoke 340 extending at a top of the arm 50 and an axle 342 fixed to a mount housing 346 of the suction cup 52 and rotationally carried by opposite arms of the yoke 340.

FIG. 10 illustrates the sensor 60, preferably an optical sensor, mounted on a flexible arm or rod 364 which guides the sensor 60 along the predominant facing surface of the case 44a. The flexible arm 364 extends from a plate 368. The plate 368 is connected to the moveable carriage 159 which is carried by the transport rod 166. The bearing 167 is mounted above the plate 368 and together with the guide rod 168 ensure stability and verticality of the sensor 60. The bearing 167, the carriage 159, the plate 368 and the sensor 60 move together along the transport rod 166.

A stationery plate 372 is oriented in the transverse path of the case 44a. A spring 374 extends upwardly in the path of the case 44a such that the case flexes the spring. The force exerted by the spring assists in opening the case 44a.

FIG. 15 illustrates the control scheme of the present invention. The controller 38 includes a programmable logic controller (PLC) 400, a servomotor drive 404 and a solenoid manifold 408 having solenoid valves responsive to an I/O section 410 of the PLC 400. The PLC 400 receives a case size signal from the sensor 60 when the sensor finds the case slot 136. If the case size has changed from the previous case size, the PLC 400 sends appropriate signals to the servomotor 46 via the drive 404 to adjust the elevation of the magazine. The PLC 400 sends a signal to the servomotor 248 via the drive 404 to adjust the longitudinal, horizontal position of the magazine 40. The PLC 400, via the drive 404, controls the stroke of the conveyor 68 and the conveyor 84 of the transport units 28, 32 respectively according to the particular size of the case, by controlling the servomotors 70, 85. The PLC 400, via the drive 404, adjusts the separation between conveyor belts 102, 104 by sending a signal to the servomotor 106.

During operation, the apparatus must be carefully timed and controlled by the controller 38. The controller 38 initiates movement of the pivot arm 50 by sending the appropriate signal via the I/O 410 and a solenoid valve within the manifold 408, to the pneumatic cylinder 164, and sends a signal via the I/O 410 and a solenoid valve within the manifold 408, to the pushers 150, 152 to lift and separate the first case 44a from the retaining lips 149 of the magazine 40. The sensors 150a, 152a confirm activation of the pushers 150, 152 to the PLC 400. The optical sensor 331 senses the correct rotational position of the pivot arm 50 about the joint 158 with respect to the leading flattened case 44a and sends a corresponding signal to the PLC 400. The controller then instigates forward pivoting of the arm 50 about the joint 154 toward the case 44a by a signal to the pneumatic cylinder 162 via the I/O 410 and a solenoid valve within the manifold 408.

The position of the suction cup 52 with regard to the case 44a is sensed by the proximity switch 320 which communicates this information to the PLC 400. The suction cup 52 can be activated by a signal from the PLC 400 via the I/O 410 and a solenoid valve within the manifold 408, to engage the leading case 44a. The pivot arm 50 can then be pivoted down about the joint 158 by the cylinder 162 to the staging area, to set the case 44a on the ledge 56.

The PLC 400 initiated movement of the sensor 60 along the transport rod 166 can then commence. The PLC 400 instigates movement of the carriage 159 from the preset home position 169 and starts a timer or clock function within the PLC 400. Upon finding the slot 136, the optical sensor communicates this position to the PLC 400 and the timer or clock function is stopped. The PLC 400 calculates the case size based on the duration of carriage travel as measured by the timer or clock function. At this point the case size is either confirmed as being appropriate for the present configuration of the apparatus 20, or if the case size has changed, plural adjustments are made by the controller 30 to accommodate the new size case.

Although a timer or clock function is used to determine the location of the sensor 60 when the slot 136 is found, other distance measuring sensors or techniques would be used, such as a servomotor or numerically encoded motor to move the carriage 159, by a magnetic or electric “yardstick” incorporated into one of the rails 166, 168, or by other means. Although a moving optical sensor is described, other sensors could be used to scan the leading flattened case to determine the case size.

Each of the servomotors which set apparatus adjustments are provided with a position feedback to the controller 38. The servomotors 248, 46, 85, 70, 106 provides position feedback respectively to the PLC 400 via the servodrive 404. The aforementioned motors can be numerical motors having numerical encoders which feedback the precise position of the respective adjustment to the controller 38.

From the foregoing, it will be observed that numerous variations and modifications may be effected without departing from the spirit and scope of the invention. It is to be understood that no limitation with respect to the specific apparatus illustrated herein is intended or should be inferred. It is, of course, intended to cover by the appended claims all such modifications as fall within the scope of the claims.

The invention claimed is:

1. A case erector used for forming cubical cases from flattened cases, the flattened cases each having four sidewalls and corresponding flaps extending therefrom, comprising:
a controller;
a magazine for holding a plurality of flattened cases, the magazine arranged to hold the plurality of flattened cases behind a leading flattened case;
a sensor operable to scan a portion of said leading flattened case of said plurality of flattened cases, said sensor operable to sense a parameter which determines a size of said leading flattened case, said sensor signal-connected to said controller; and
a means for manipulating the leading flattened case to open the flattened case into a rectangular tube and to close flaps of said leading flattened case to form a closed end, wherein said means automatically adjusts for case size in response to a signal by said controller.

2. The case erector according to claim 1, wherein said means for manipulating comprises at least one transport and a plurality of ploughs, said transport engaging said leading flattened case and moving said leading flattened case against said ploughs to open said leading flattened case into said rectangular tube and to close said end flaps of said leading flattened case to define said closed end of said leading flattened case; and
wherein at least one of said transports is adjusted by said controller by the size of said leading flattened case.

3. The case erector according to claim 1, comprising a staging transport, said staging transport operable to remove successive flattened cases from said magazine and place said cases on a surface adjacent to said sensor, said surface substantially horizontal.

4. The case erector according to claim 1, wherein said means for manipulating comprises at least one transport and a plurality of ploughs, said transport engaging said leading flattened case and moving said leading flattened case against said ploughs to open said leading flattened case into said rectangular tube and to close said end flaps of said leading flattened case to define said closed end of said leading flattened case;
wherein at least one of said transports is adjusted by said controller by the size of said leading flattened case wherein said at least one transport comprises a lateral transport and a longitudinal transport, said lateral transport moveable to engage said leading flattened case and draw said leading flattened case in a lateral direction, moving said leading flattened case in said lateral direction causing a portion of said leading flattened case to be pressed to a stationary plough to open said leading flattened case from a flattened condition to a rectangular cross-section, said lateral transport moving said leading flattened case to a handoff position; and
said longitudinal transport moveable to engage said leading flattened case at said handoff position and moveable to push said leading flattened case longitudinally, said longitudinal transport including a pivotable plate to close a rear flap of said end of said leading flattened case.

5. The case erector according to claim 4, further comprising a case conveyor located in line with said longitudinal transport, and a front flap stationary plough and side flap stationary ploughs arranged along said case conveyor, movement of said leading flattened case along said case conveyor causing a front flap of said end of said leading flattened case to be folded closed and said side flaps of said end of said leading flattened case to be folded closed onto said front flap.

6. The case erector according to claim 5, wherein said case conveyor comprises opposing conveyor belts having conveyor surfaces arranged in vertical planes, said conveying surfaces adjustably spaced by a conveying adjuster, and said conveying adjuster is signal-connected to said controller wherein said controller can adjust the horizontal space between the conveying surfaces in response to a case size signal from said sensor.

7. The case erector according to claim 1, wherein said magazine is adjustably mounted vertically by a vertical adjuster and said controller is signal-connected to said vertical adjuster to adjust the height of said magazine with respect to said transport, said height of said magazine adjustable corresponding to a case size sensed by said sensor.

8. The case erector according to claim 1, wherein said means for manipulating comprises at least one transport and a plurality of ploughs, said transport engaging said leading flattened case and moving said leading flattened case against said ploughs to open said leading flattened case into said rectangular tube and to close said end flaps of said leading flattened case to define said closed end of said leading flattened case; and
wherein at least one of said transports is adjusted by said controller by the size of said leading flattened case wherein a lateral movement distance of said lateral transport is set by said controller according to a case size signal from said sensor, and the longitudinal movement of said longitudinal transport is controlled by said controller according to a case size signal from said sensor.

9. The case erector according to claim 1, further comprising at least one pneumatic pusher, said pneumatic pusher arranged adjacent to the front face of said magazine and operable to displace said leading flattened case in an oblique direction from remaining cases in the magazine.

10. The case erector according to claim 1, wherein said sensor comprises an optical sensor moveable with respect to said predominant face and configured to sense the position of a flap defining slot on said predominant face; and a position sensor; and said controller configured to recognize the location of the slot based on signals from the optical sensor and the position sensor.

11. The case erector according to claim 10, wherein said position sensor comprises a timer that is configured to measure the travel time of said optical sensor from a home position to the slot.

12. The case erector according to claim 1, wherein said magazine comprises a rack having a V-shaped cross-section defined by first and second support surfaces, said first and second support surfaces being tilted obliquely from vertical.

13. A magazine for delivering flattened cases into a case erector apparatus comprising:
a rack having a V-shaped cross-section defined by first and second support surfaces, said first and second support surfaces being tilted obliquely from vertical.

14. The magazine according to claim 13, wherein said rack is tilted downwardly toward said magazine outlet, said first and second support surfaces each having at least one retaining lip at said outlet.

15. The magazine according to claim 13, comprising a staging platform adjacent said magazine outlet, outside of said rack, and further comprising a staging transport mounted to said magazine, said staging transport having a lever arm that is engageable to a leading case at said magazine outlet and being controllably moveable to retract said leading case from said rack and to move said leading case onto said staging platform.

16. The magazine according to claim 15, further comprising a sensor adjacent to said staging platform, said sensor operable to determine the size of said case.

17. The magazine according to claim 15, wherein said lever arm comprises a suction cup arranged on an end of said lever arm and engageable to said leading case.

18. The magazine according to claim 13, further comprising a controllable lift mechanism operatively engaged to said rack for vertical adjustment of said rack.

19. The magazine according to claim 13, further comprising a controllable shift mechanism operatively engaged to said rack for horizontal adjustment of said rack.
